(19) United States
(12) Patent Application Publication
(10) Pub. No.: US 2013/0164999 A1
(43) Pub. Date: Jun. 27, 2013

(54) SERVER WITH POWER SUPPLY UNIT

(71) Applicants: TING GE, Shenzhen City (CN); YA-JUN PAN, Shenzhen City (CN)

(72) Inventors: TING GE, Shenzhen City (CN); YA-JUN PAN, Shenzhen City (CN)

(21) Appl. No.: 13/664,433

(22) Filed: Oct. 31, 2012

(30) Foreign Application Priority Data
Dec. 27, 2011 (CN) 201110444462.9

(51) Int. Cl. H01R 4/30

(52) U.S. Cl. 439/801

(57) ABSTRACT

A server includes an enclosure made of conductive material defining a first through hole and a second through hole, a power supply unit (PSU) converting alternating current power into direct current voltages, a motherboard, and first and second fasteners. The PSU includes a first power connector and a ground connector, and defines a screw hole. The ground connector is coupled to a shell of the PSU and a ground line of a plug of the PSU that receives the alternating current power. The motherboard includes a second power connector connected to the first power connector, and defines a fixing hole coated with conductive material electrically connected to a ground layer of the motherboard. The first fastener extends through the first through hole to engage in the screw hole of the PSU, and the second fastener extends through the second through hole to engage in the fixing hole.

### BACKGROUND

1. Technical Field

The present disclosure relates to a server including a power supply unit.

2. Description of Related Art

A power supply unit (PSU) 10 for a server, shown in FIG. 2, includes a plurality of wires, and a plurality of plugs electrically connected to the wires to output various direct current voltages to power different components. In order to prevent electromagnetic interference among the components, each component includes a ground pin coupled to a ground layer of a circuit board of the server. The ground layer, then, is coupled to ground pins of the plug 20. The ground pins are coupled to a ground line of a power plug 100 of the PSU 10, thereby enabling the ground pin of each component to be connected to ground of a commercial power source. However, the PSU 10 may include a plurality of ground wires, such as the wires connected to the 8-pin plug includes five ground wires, which occupies a lot of space of the server.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of a server of the present disclosure, wherein the server includes a power supply unit.

FIG. 2 is a power supply unit of a related art.

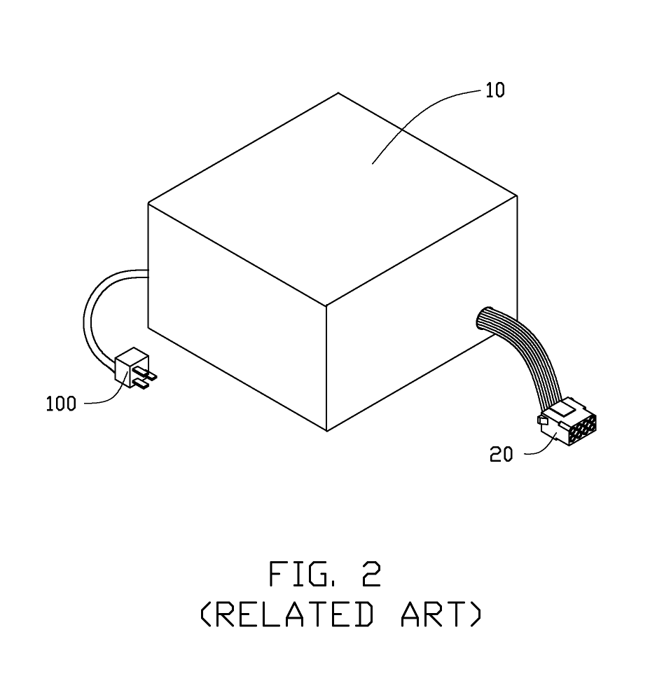

### DETAILED DESCRIPTION

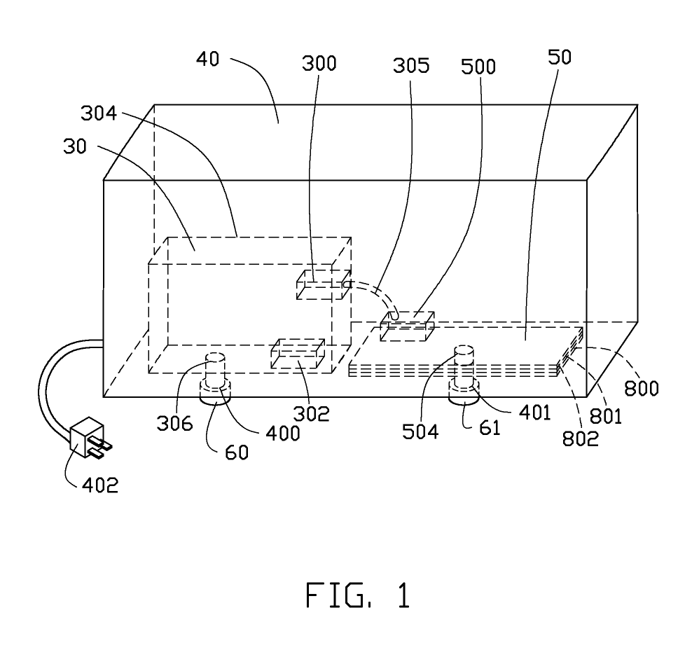

FIG. 1 illustrates an embodiment of a server of the present disclosure. The server includes an enclosure 40, a motherboard 50 arranged in the enclosure 40, a power supply unit (PSU) 30 arranged in the enclosure 40, a first fastener 60, and a second fastener 61.

The enclosure 40 is made of conductive material, such as metal, and defines both a first through hole 400 and a second through hole 401 in a bottom wall of the enclosure 40.

The motherboard 50 includes at least one signal layer 801, a power layer 802, a ground layer 800, and a power connector 500 arranged on a top of the motherboard 50. The power connector 500 is electrically coupled to the power layer 802 of the motherboard 50. Ground pins of a plurality of components arranged on the motherboard 50 are electrically coupled to the ground layer 800 of the motherboard 50. A fixing hole 504 is defined in the motherboard 50, extending through a top and bottom of the motherboard 50. An inner sidewall of the fixing hole 504 is coated with conductive material electrically coupled to the ground layer 800 of the motherboard 50.

The PSU 30 is used to convert commercial alternating current power into direct current voltages, and includes a shell 304 made of conductive material, such as metal, a power connector 300 arranged on the shell 304, and a ground connector 302 arranged on the shell 304. The ground connector 302 is electrically coupled to the shell 304 and a ground wire of a plug 402 by which the PSU 30 receives the commercial alternating current power. The power connector 300 is electrically coupled to power wires of the plug 402. A screw hole 306 is defined in a bottom of the shell 304.

The first fastener 60 is configured to connect the enclosure 40 to the shell 304. The second fastener 61 is configured to connect the motherboard 50 to the enclosure 40. The first and second fasteners 60 and 61 are made of conductive material, such as metal. In the embodiment, the first and second fasteners 60 and 61 are screws.

In use, the first fastener 60 extends through the first through hole 400 to engage in the screw hole 306, and the second fastener 61 extends through the second through hole 401 to engage in the fixing hole 504. Therefore, the enclosure 40 is electrically coupled to the shell 304 and the ground layer of the motherboard 50. The power connector 300 is electrically coupled to the power connector 500 through a power line 305. Accordingly, the ground pins of the components of the motherboard are electrically coupled to the ground wire of the plug 402 through the ground layer 800, the fixing hole 504, the second fastener 61, the enclosure 40, the first fastener 60, the shell 304, and the ground connector 302 in that order.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A server, comprising:
an enclosure made of conductive material, and defining a first through hole and a second through hole;
a motherboard arranged in the enclosure, and comprising a ground layer, a power layer, a first power connector arranged on the motherboard and electrically coupled to the power layer, the motherboard defining a fixing hole coated with conductive material electrically coupled to the ground layer;
a power supply unit (PSU) converting alternating current power into direct current power, and comprising a shell made of conductive material, a plug to receive the alternating current power, a second power connector arranged on the shell and electrically coupled to a power wire of the plug, and a ground connector arranged on the shell and electrically connected to the shell and a ground wire of the plug, the shell defining a screw hole; and
a first fastener and a second fastener both made of conductive material;
wherein the first power connector is connected to the second power connector through a power line, the first fastener extends through the first hole of the enclosure, to engage in the screw hole of the shell of the PSU, and the second fastener extends through the second hole of the enclosure, to engage in the fixing hole of the motherboard.

2. The server of claim 1, wherein the first fastener is a screw.

3. The server of claim 1, wherein the second fastener is a screw.
